(19) United States
(12) Patent Application Publication
(10) Pub. No.: US 2011/0302058 A1
(43) Pub. Date: Dec. 8, 2011

(54) CONTENT PLAYBACK APPARATUS, CONTENT PLAYBACK METHOD, PROGRAM, AND RECORDING MEDIUM

(76) Inventors: Masaki HASHIURA, Osaka-shi (JP); Gen AOYAMA, Osaka-shi (JP); Yoshinari SAWATA, Osaka-shi (JP); Akira OGAWA, Osaka-shi (JP)

(21) Appl. No.: 13/153,501

(22) Filed: Jun. 6, 2011

(30) Foreign Application Priority Data
Jun. 7, 2010 (JP) 2010-129771

(51) Int. Cl. G06Q 30/00

(52) U.S. Cl. 705/27.1

(57) ABSTRACT

Provided is a content playback apparatus capable of presenting, while playback a digital content, selling price information for the digital content being reproduced. The content playback apparatus is provided with a content playback portion which reproduces a digital content, a selling price information obtaining portion which obtains selling price information concerning the digital content, and a selling price information presentation portion which presents the obtained selling price information. The selling price information presentation portion presents, during playback of a digital content, the selling price information concerning the digital content.

### CROSS-NOTING PARAGRAPH

This non-provisional application claims priority under 35 U.S.C. §119(a) on Patent Application No. 2010-129771 filed in JAPAN on Jun. 7, 2010, the entire contents of which are hereby incorporated herein by reference.

### FIELD OF THE INVENTION

The present invention relates to a content playback apparatus that reproduces a digital content, a content playback method, a program, and a recording medium.

### BACKGROUND OF THE INVENTION

Recently, such a use form is widely spread among users that a digital content in which a content such as a book, music or a movie is digitized is enjoyed by viewing/listening with use of a content playback apparatus such as an electronic book terminal or a media player (music player or AV player).

A digital content includes a pay digital content that requires a consideration for viewing/listening it and a free digital content that does not require the consideration. The pay digital content is a content whose sales right is held by a publisher or a record company that contracts with a copyright owner thereof, and is sold to users via real shops and online stores as with purchasing books, CDs or DVDs which are the conventional non-digital contents.

As a major method for purchasing a pay digital content by a user, purchasing and downloading from an online store using the internet is performed. Meanwhile, it is common to use copyright protection technologies with which viewing/listening rights is strictly managed or users are not able to duplicate or distribute the pay digital content without permission in order to enable only publishers, record companies or the like holding the sales rights to sell pay digital contents, since disclosure of digital data on the internet is able to be easily performed by users even without a deep and special knowledge.

With such an advance of the copyright protection technologies and an advance of the internet technologies, users are able to purchase for viewing/listening a digital content immediately online by paying a consideration therefor when the user wishes to view/listen the content, however, it is easy to image that with further increase of a distribution amount of the digital contents, there will be a greater demand by users not only for purchasing digital contents but also for reselling for other users digital contents that are no longer needed (namely, exchanging for cash) in the near future.

When a world in which digital contents are frequently purchased and sold will come, the digital contents will be able to be handled with as something valuable such as a kind of securities.

Japanese Laid-Open Patent Publication No. 2003-132209 discloses a digital content trading system which enables electronic trading of a digital content in which copyright is changed into securities and current price display of a digital content whose price fluctuates and copyright related information are browsed. Furthermore, Japanese Laid-Open Patent Publication No. 2007-11806 discloses a screen example of a terminal device for performing purchase/sales transaction with respect to a digital content which is changed into securities as with the case of Japanese Laid-Open Patent Publication No. 2003-132209.

However, the digital content transaction described in Japanese Laid-Open Patent Publication No. 2003-132209 and Japanese Laid-Open Patent Publication No. 2007-11806 are not taking into account that the digital content is a medium to enjoy viewing/listening by playback the digital content itself, which is different from the securities such as stock securities. Therefore, there is a problem that in a case where a current price of the digital content is varied from moment to moment during playback of the digital content held by the user, which is not able to be known by the viewing/listening user.

For instance, it is assumed that a user starts to read again an electronic book from a page where he/she has stopped reading, which has been purchased at a current price of 1,000 yen, during one-hour each way ride of commuter train. Note that the user desires to sell off the book when it reaches 800 yen even when he/she has not finished reading. However, it is assumed that the current price has begun to decline at a rate of 100 yen per 15 minutes immediately after starting to read the book, and the current price is declined to 600 yen during 1 hour from getting on to getting off the train.

In such a case, in the conventional technologies, there is no means to know the decline of the current price of the electronic book currently being read unless playback of the electronic book is once interrupted and confirmation of the current price is made, resulting in the user missing a chance to sell off the book at a desired price in most cases.

### SUMMARY OF THE INVENTION

An object of the present invention is to provide a content playback apparatus, a content playback method, a program, and a recording medium that are capable of presenting, while playback a digital content, selling price information for the digital content being reproduced.

A first technical means of the present invention is a content playback apparatus comprising: a content playback portion which reproduces a digital content; a selling price information obtaining portion which obtains selling price information concerning the digital content; and a selling price information presentation portion which presents the selling price information; wherein the selling price information presentation portion presents the selling price information concerning the digital content during playback of the digital content.

A second technical means of the present invention is the content playback apparatus as defined in the first technical means, wherein the selling price information presentation portion presents the selling price information in a case where selling price information presentation conditions set in advance are satisfied.

A third technical means of the present invention is the content playback apparatus as defined in the first technical means, wherein an operation receiving portion is provided which receives a presentation operation for executing presentation by the selling price information presentation portion during playback of the digital content, and the selling price information presentation portion executes presentation of the selling price information when the presentation operation is received.

A fourth technical means of the present invention is the content playback apparatus as defined in the first technical means, wherein a state accumulation portion is provided which accumulates playback state information showing a playback state of the digital content for each of the digital content, and the selling price information obtaining portion obtains the selling price information corresponding to the playback state information concerning the digital content being reproduced.

A fifth technical means of the present invention is the content playback apparatus as defined in the fourth technical means, wherein the selling price information presented by the selling price information presentation portion includes estimate selling price information which is estimated from the playback state information.

A sixth technical means of the present invention is the content playback apparatus as defined in the first technical means, wherein the selling price information obtaining portion obtains the selling price information concerning the digital content from a server device connected to the content playback apparatus via a network.

A seventh technical means of the present invention is a content playback method for reproducing a digital content by a content playback apparatus including: an obtaining step in which a selling price information obtaining portion obtains selling price information concerning the digital content; and a presenting step in which a selling price information presentation portion presents the selling price information obtained at the obtaining step, wherein the presenting step performs presentation of the selling price information concerning the digital content during playback of the digital content.

An eighth technical means of the present invention is a program for reproducing a digital content in which a computer is caused to execute an obtaining step for obtaining selling price information concerning the digital content, and a presenting step for presenting the selling price information obtained at the obtaining step, wherein the presenting step performs presentation of the selling price information concerning the digital content during playback of the digital content.

A ninth technical means of the present invention is a computer-readable recording medium in which the program as defined in the eighth technical means is recorded.

### BRIEF DESCRIPTION OF THE DRAWINGS

FIG. 1 is a diagram showing a configuration example of a content purchase/sales system including a content playback apparatus according to the present invention;

FIG. 2 is a block diagram showing a configuration example of the content playback apparatus according to the present invention;

FIG. 3A and FIG. 3B are diagrams showing an example of a presentation screen of selling price information in a display portion of the content playback apparatus of FIG. 2;

FIG. 4 is a diagram showing an example of a component of a program to be incorporated into a control portion in the content playback apparatus of FIG. 2; and

FIG. 5 is a flowchart for describing an example of selling price information presentation processing in the content playback apparatus of FIG. 2.

### PREFERRED EMBODIMENTS OF THE INVENTION

A content playback apparatus according to the present invention is an apparatus provided with a content playback portion which reproduces a digital content of a video image and/or sound. The content playback apparatus according to the present invention includes, for example, a portable-type device such as an electronic book terminal, a mobile PC, a mobile phone, a Personal Digital Assistance (PDA), a portable music player, or a portable AV player, however, is not limited thereto and also includes, for example, an installation-type device such as a desktop-type PC, an installation-type music player, an installation-type AV player or recorder, or a television device.

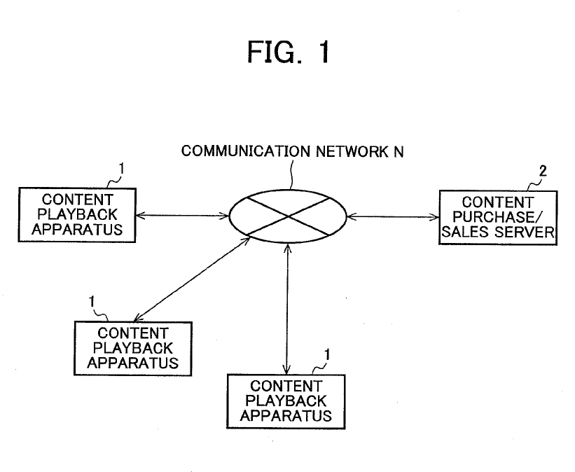

Furthermore, the content playback apparatus according to the present invention is an apparatus capable of presenting selling price information while playback a digital content, assuming a digital purchase/sales transaction market in which the selling price information including a current price of the digital content varies from moment to moment. Description will be given for such a content purchase/sales system for forming such a market including the content playback apparatus according to the present invention with reference to FIG. 1.

FIG. 1 is diagram showing a configuration example of a content purchase/sales system including a content playback apparatus according to the present invention. In the content purchase/sales system illustrated in FIG. 1, a content playback apparatus 1 and a content purchase/sales server 2 which is an example of a server device are connected to a communication network N such as an internet wiredly or wirelessly, respectively. In the system, it is configured that a plurality of content playback apparatuses 1 are connected to one content purchase/sales server 2 so that each of the playback apparatuses 1 is capable of communicating with the content purchase/sales server 2, and each is able to be used by a different user.

The content purchase/sales server 2 is a server for performing purchase/sales transaction processing of digital contents. Note that, it is assumed that the content purchase/sales server 2 is included in the content purchase/sales system in which the processing of receiving and transmitting the digital content itself is performed for purchasing and selling the digital contents, however, may be connected to a communication network independently from the system for transmitting and receiving the contents so as to operate in conjunction with the system.

Description in detail will be given for the content purchase/sales server 2. The content purchase/sales server 2 receives a purchase/sales order request from a content playback apparatus 1 or a not-shown purchase/sales execution terminal such as a common Internet terminal (PC, mobile phone, etc.), and in the case where purchase/sales conditions (purchase/sales desired price or quantity) are matched in each digital content, when a purchase order is established, the digital content is made to be reproducible, and conversely, when a sell order is established, the digital content is made to be irreproducible. That is, a user holds rights to reproduce the digital content from the establishment of the purchase order to the establishment of the sell order.

Here, as a method of controlling possibility/impossibility of playback each digital content, a mechanism of protecting copyright that is commonly put into practical use is utilized. For example, the method is that, at the time of starting playback of a digital content in the content playback apparatus 1, an inquiry is made to the content purchase/sales server 2 whether or not the apparatus 1 holds the rights to reproduce the digital content. Subsequently, only when the content playback apparatus 1 that has inquired holds the playback rights for the digital content, the content purchase/sales server 2 obtains a license key which enables playback from an internal storage device or a not-shown license server, and only when the license key is able to be obtained, the digital content is able to be reproduced.

Note that, assuming a case where the purchase/sales execution terminal with which purchase/sales transaction has been performed is different from the content playback apparatus 1 for playback a digital content, it is preferable that at the time of starting the purchase/sales transaction processing or at the time of starting playback possibility/impossibility inquiries of the digital content as described above, a user ID with which a user is able to be uniquely specified is notified to the content purchase/sales server 2 so that the playback rights of each digital content is managed for each user ID.

Furthermore, the content purchase/sales server 2 has a selling price information database which accumulates selling price information of each digital content. The selling price information database is to manage in a table for each digital content, content specification information (content ID) for identifying a content and the selling price information. The selling price information is a selling price necessary when selling a digital content or information which is able to be referenced and shows, for example, a current price, current price fluctuation history (current price fluctuation chart), total number of market circulation, trading volume, and the like. The selling price information database accumulates the selling price information for each content specification information based on results of the purchase/sales transaction processing. Moreover, user comments such as book reviews posted from common internet terminals or an evaluation rate set by a publisher or an operator of an online store may also be managed. The selling price information, of course, may be a combination of a plurality of types thereof, however, preferably includes at least the current price for purchasing and selling. However, selling at an asked price may also be assumed, and the current price is thus not necessarily needed to be included.

Furthermore, in the selling price information database, the selling price information changed according to a playback state of a content, for example, the current price that is increased/decreased according to the playback state of the content, may be registered. Here, the selling price information for each level showing the playback state of the content may be registered. It is thus possible to make the selling price information (current price, for example) fluctuate according to playback state history of each digital content.

As a relation between the playback state and the current price, for a example, a relation in which the selling price goes down with the increase of the number of playback times, namely, a relation in which a value of a new product is high and a value of a product which is viewed/listened a number of times decreases, may be employed, as with the way of thinking about the used market of used books and the like at present even in the case of handling the digital content. Note that, basically, it is assumed that the current price does not change according to the reproduced length of the digital contents and the content is able to be viewed/listened from the beginning even in the case of reselling. Moreover, since it is assumed a case where a digital content to which an impact is applied becomes a video image that is difficult to be viewed/listened or deteriorated, such a case may be judged from the history so that the current price is lowered. That is, a level of impact may be rated as higher when the number of times of applied impact received from the content playback apparatus 1 is larger. A current price maybe registered for each combination of the number of playback times and the received impact level, or alternatively, one current price is registered for one digital content (for example, a high-quality version of a movie “A”), and lowering the current price only by an amount of a predetermined price according to the number of playback times or lowering the current price only by an amount of a predetermined price according to a received impact level may be performed.

Furthermore, selling price information such as a current price according to a location where the content is reproduced may be registered. A combination of the selling price information according to the location and the selling price information according to the number of playback times and the impact level is similar to the description given for the relation between the number of playback times and the impact level. The current price according to the location, even for the digital content, may be decided assuming that, for example, when a content is always viewed/listened indoors, deterioration of the content is small, and when viewed/listened outdoors, deterioration of the contents becomes greater. Additionally, by using the mechanism on the contrary, it is possible to realize a new method of purchasing and viewing/listening a digital content in which a value of a content is increased by being brought to a concert venue of an artist thereof, or by being brought to a local venue which is a locale of a movie.

Additionally, the content purchase/sales server 2 has a selling price information distribution function of providing selling price information data of each digital content according to a request from the content playback apparatus 1. The selling price information distribution function may read out each selling price information from the selling price information database for transmitting to the content playback apparatus 1 as a numeral value or a character string, or may generate image data of JPEG or PNG which is visualized graphically or by using characters, or document data using description language such as HTML, based on each selling price information for transmission.

Further, the content purchase/sales server 2 includes a digital content distribution function, a settlement processing function of purchase/sales payment, a function of providing purchase/sales order state for the purchase/sales execution terminal, and the like, other than the purchase/sales processing as described above. Note that, the content purchase/sales server 2 may be composed of a plurality of servers and each of the functions may be distributed to those servers.

On the other hand, the content playback apparatus 1 has a function of playback at least a digital content, and a function of obtaining selling price information concerning the digital content from the content purchase/sales server 2 via a communication network N to present in the content playback apparatus 1. Note that, description for each function, exemplary module configuration, and flow of the processing in the content playback apparatus 1 will be given below.

That is, the content playback apparatus 1 according to the present invention is provided with a content playback portion which reproduces a digital content, a selling price information obtaining portion which obtains selling price information concerning a digital content, and a selling price information presentation portion which presents the selling price information to a user.

The above-described selling price information presentation portion then performs, during playback of a digital content, presentation of the selling price information concerning the digital content, as a main characteristic of the present invention. In playback the digital content in the content playback apparatus 1 (or possibly in playback by streaming), the selling price information presentation portion gives an instruction to the selling price information obtaining portion, and the selling price information obtaining portion transmits a request including content specification information corresponding to the digital content being reproduced to the content purchase/sales server 2 to obtain selling price information in response thereto, and the selling price information presentation portion presents the selling price information, thus enabling presentation of the selling price information even during playback of the digital content.

Here, the content specification information is information which is enclosed in the digital content or obtained simultaneously with digital content data at the time of purchasing the digital content and managed correspondingly thereto inside the digital content playback apparatus, which enables the content purchase/sales server to specify the corresponding selling price information based on the content specification information. Furthermore, the content purchase/sales server 2 manages the selling price information of each digital content as described above and at least includes a database which returns the selling price information corresponding to the content specification information specified according to the request from the content playback apparatus 1.

Note that, description is given assuming that the selling price information concerning the digital content being reproduced is obtained from the content purchase/sales server 2 by a request from a side of the content playback apparatus 1, however, in order to obtain the selling price information, selling price information may also be transmitted spontaneously from a side of the content purchase/sales server 2. However, when the selling price information of all the digital contents which is expected to be an enormous number is transmitted at a certain degree of update frequency (once in a few minutes, for example) from the side of the content purchase/sales server 2, an amount of transmitted/received data becomes enormous, and when a load of transmitting processing on the side of the content purchase/sales server 2 or a capacity of a memory and a processing load on the side of the content playback apparatus 1 are considered, it is preferable to transmit the content specification information to the content purchase/sales server 2.

Moreover, the presentation of the selling price information in the content playback apparatus 1 includes the performance of displaying on a display screen on which a digital content or meta-information such as a title or an author of the digital content is displayed, presenting by outputting sound from an ear phone or a speaker, and presenting by combining thereof, and the like, however is not limited thereto, and may be replaced with other methods being perceptible by a user, such as transmission by vibration.

Hereinabove, according to the present invention, it is possible to present the selling price information varied from moment to moment while playback the digital content, therefore a user is able to view/listen the digital content while keeping track of a current price, etc., all the time.

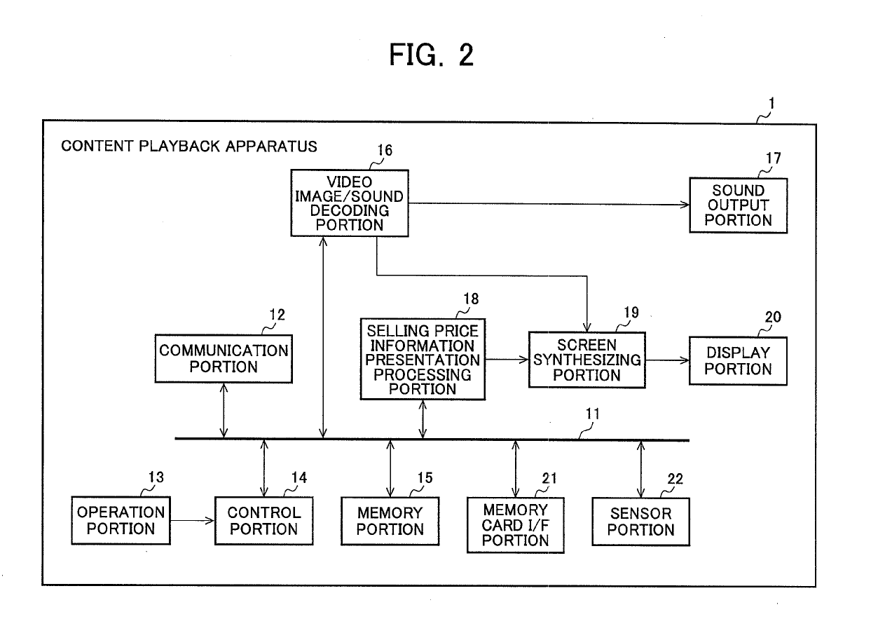

Next, with reference to FIG. 2, description will be given for a hardware configuration example of the content playback apparatus 1. FIG. 2 is a block diagram showing a configuration example of the content playback apparatus according to the present invention, and is a diagram showing an example of the hardware configuration of the content playback apparatus 1 in the system of FIG. 1.

The content playback apparatus 1 illustrated in FIG. 2 has a bas 11, a communication portion 12, an operation portion 13, a control portion 14, a memory portion 15, a video image/sound decoding portion 16, a sound output portion 17, a selling price information presentation processing portion 18, a screen synthesizing portion 19 and a display portion 20. The selling price information obtaining portion as described above is able to be illustrated mainly by the control portion 14 and the communication portion 12. Additionally, the selling price information presentation portion as described above is able to be illustrated mainly by the selling price information presentation processing portion 18, the screen synthesizing portion 19, the display portion 20 and the sound output portion 17.

The bus 11 is to connect each of the portions 12 to 20 directly or indirectly. The communication portion 12 performs communication by connecting with a communication network N such as the internet. The operation portion 13 receives a user operation. The control portion 14 controls each portion by calling each portion. The memory portion 15 stores a digital content that is downloaded, stores history of content state information, and stores a user ID of a user who is using the content playback apparatus 1. The video image/sound decoding portion 16 decodes video image data or sound data of the digital content. The sound output portion 17 outputs a sound signal that is decoded in the video image/sound decoding portion 16. The selling price information presentation processing portion 18 performs processing for presenting the selling price information stored in the memory portion 15. The screen synthesizing portion 19 synthesizes the video image signal decoded in the video image/sound decoding portion 16 and the selling price information display data processed by the selling price information presentation processing portion 18. The display portion 20 displays a screen synthesized by the screen synthesizing portion 19.

Note that, when the digital content which is started to be reproduced is protected by the copyright protection technology, the control portion 14 executes the playback procedure in accordance with the copyright protection method as described above prior to the playback of the digital content, and only in the case where the playback is possible, playback processing is requested to the video image/sound decoding portion 16.

Furthermore, the content playback apparatus 1 of FIG. 2 has a memory card I/F portion 21. The memory card I/F portion 21 is an interface capable of reading out a digital content from a memory card such as an SD® (secure digital) memory card, an MMC® (multimedia card), a memory stick® and the like, and having this makes it possible to reproduce a digital content purchased via an other content playback apparatus 1 or a common internet terminal.

Moreover, the content playback apparatus 1 of FIG. 2 has a sensor portion 22 which senses a condition in which the content playback apparatus 1 is placed for accumulating in the memory portion 15. As examples of the sensor portion 22, an acceleration sensor, an impact sensor, an illuminance sensor, a temperature sensor, a humidity sensor, a GPS (Global Positioning system) sensor, an ultraviolet sensor and the like are included, and a plurality of sensors may be provided therein.

With such a configuration, the content playback apparatus 1 is able to realize a function of playback a digital content on the Internet or a digital content stored in a memory card by a user operation and a function of presenting selling price information obtained by the content purchase/sales server 2.

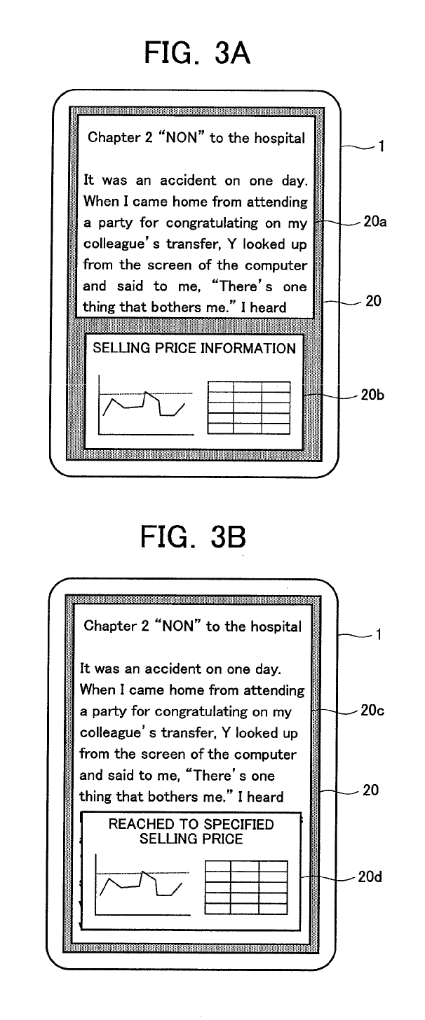

Next, description will be given for a presentation example of selling price information in the selling price information presentation portion of the content playback apparatus 1 with reference to FIG. 3A and FIG. 3B. FIG. 3A and FIG. 3B are diagrams showing examples of presentation screens of selling price information in a display portion of the content playback apparatus of FIG. 2, and FIG. 3A and FIG. 3B show examples of presentation screens which are different from each other.

In the screen example shown in FIG. 3A, a content display area 20a which is playback and displaying an electronic book content as an example of a digital content on the display portion 20 of the content playback apparatus 1, and a selling price information display area 20b which is displaying selling price information concerning the electronic book are displayed on separate areas so as not to overlap with each other. In this example, in the selling price information display area 20b, a chart showing a time dependent change of a current price and a table showing an actual price thereof are displayed. In the case of the example, the screen synthesizing portion 19 performs processing to synthesize the content display area 20a and the selling price information display area 20b, as separated areas. Thereby, confirmation of the selling price information of a digital content is possible while viewing/listening the digital content.

Furthermore, the display may be switched so that the selling price information display area 20b is displayed only after the operation portion 13 receives a selling price information display operation event and the control portion 14 makes a selling price information display request to the selling price information presentation processing portion 18. For example, the content display area 20a is kept as an entire screen of the display portion 20, and only when the selling price information display operation is performed by the operation portion 13, both the areas 20a and 20b may be synthesized to be displayed by reducing the content display area 20a so as to secure the selling price information display area 20b. On the other hand, when the operation portion 13 receives a selling price information non-display operation event, the control portion 14 makes a selling price information non-display request to the selling price information presentation processing portion 18, and the display thus may be switched not to display the selling price information display area 20b. In this case, the content display area 20a may be returned to be the entire screen of the display portion 20.

In this manner, the content playback apparatus 1 is preferably provided with an operation receiving portion which receives a presentation operation for executing presentation by the selling price information presentation portion while playback the digital content. The selling price information presentation portion may then execute presentation of the selling price information when receiving the presentation operation. The displaying of the selling price information is thereby possible only when the user desires to confirm the selling price information, and there is an effect of not disturbing viewing/listening of the content.

In a screen example shown in FIG. 3B, the selling price information display area 20d is displayed on the content display area 20c so as to overlap therewith. In the case of the example, in the screen synthesizing portion 19, processing to superimpose the selling price information display area 20d on the content display area 20c is performed. Then, in the screen example, the selling price information display area 20d is able to be displayed like a pop-up screen, and thus is suitably utilized as a form in which the presentation is performed at the time of presentation operation as described above. Of course, the selling price information display area 20d may overlap the content display area 20c to be displayed all the time.

Further, the above-described selling price information presentation portion in the content playback apparatus 1 preferably presents selling price information in the case where selling price information presentation conditions set in advance are satisfied. Here, the selling price information presentation conditions may be set at least by a user of the content playback apparatus 1, and may be set for each digital content by operating the content playback apparatus 1 or by operating an other apparatus which is connectable to the content purchase/sales server 2. Hereinafter, since an example of presenting the selling price information by displaying thereof is mainly described, the selling price information presentation conditions are referred to as the selling price information display conditions. The selling price information display conditions include various conditions such that the selling price information is obtained sequentially and a current price lowers a price of a predetermined value or a predetermined rate of an original price, playback of a predetermined rate of the digital content is finished (⅓ thereof has already been read, for example), and the like.

With reference to the example of FIG. 2, it is described that only when the selling price information presentation processing portion 18 determines that the selling price information becomes the state of satisfying the selling price information display conditions set in advance and stored in, for example, the memory portion 15 by a user, the selling price information display area may be displayed. The selling price information is thus displayed only when the conditions are that the user wishes to display the selling price information, whereby there is an effect of not disturbing viewing/listening of a content.

In this manner, it is configured that the selling price information is presented only when the selling price information display conditions set in advance are satisfied during playback of a digital content, whereby the selling price information is able to be presented so as not to disturb viewing/listening of the digital content until a condition becomes a desired one. That is, a user is able to know the current price and the like timely while viewing/listening is not unnecessarily disturbed.

Furthermore, the display method of the selling price information is not limited to the screen example as described above, and may be a display method by which the same effect is produced. For example, it is considered a pattern in which a position relation of the content display area and the selling price information display area or a size relation of the areas is differentiated, a pattern in which in a case where the operation portion 13 receives a selling price information display operation event or the selling price information presentation processing portion 18 determines that the selling price information has become the state of satisfying the selling price information display conditions set in advance by a user, such display is performed that the content display area 20a is reduced from the entire screen display into a size shown in FIG. 3A and the selling price information display area 20b is slotted into a vacant area from below, and a pattern in which the selling price information display area 20d is enlarged from a size smaller than the one shown in FIG. 3B to become the state of FIG. 3B. Furthermore, with respect to a combination of a form of presenting the selling price information only when the selling price information presentation operation is made and a form of presenting thereof only in the case where the selling price information display conditions are satisfied, an example in which both the processing is mounted as an independent processing is described, however, determination of the above-described selling price information display conditions may be performed only when the selling price information presentation operation is performed, for example.

Additionally, although it is not shown, the selling price information presentation processing portion 18 may convert the selling price information into a sound signal to be output from the sound output portion 17 as a sound reading the selling price information or a sound effect which enables a user to know that the selling price information is updated. Further, in this case also, so as not to disturb viewing/listening of the digital content, the output is preferable to be performed only in the case where the operation portion 13 receives a selling price information display operation event or the selling price information presentation processing portion 18 determines that the selling price information has become the state of satisfying the selling price information display conditions set in advance by a user.

Furthermore, it is preferable that the content playback apparatus 1 includes a state accumulation portion for accumulating playback state information (content state information) showing a playback state of a digital content for each digital content, and the above-described selling price information obtaining portion obtains the selling price information corresponding to the playback state information concerning the digital content being reproduced. The above-described state accumulation portion is able to be illustrated by, for example, a memory portion 15 which is an accumulation destination and the control portion 14 that performs the accumulation processing. Note that, obtainment is basically executed based on an instruction from the above-described selling price information presentation portion. The content playback apparatus 1 transmits the content state information and the content specification information to the content purchase/sales server 2 in this manner, whereby, in response thereto, the selling price information according to the playback state is able to be obtained and presented.

Such an obtaining method is able to be incorporated as processing independent from the form of presenting in accordance with the selling price information display conditions or the selling price information presentation operation as described above. That is, the selling price information corresponding to the playback state information may be obtained in the case where the selling price information display conditions are satisfied or in the case where the selling price information presentation operation is made, as described above.

Note that, the playback state information (content state information) is history information on how a digital content is reproduced, and for example, history in which the number of playback times of a digital content is recorded, or history in which a location where a digital content is reproduced or addition of an impact of more than a given amount in the content while being reproduced are recorded by the sensor portion 22 provided in the content playback apparatus 1. These are as described for the registration of the selling price information according to the content playback state in the content purchase/sales server 2. The selling price information database of the content purchase/sales server 2 obtains a playback state concerning the digital content, whose selling price information is requested, from the content state information transmitted from the content producing apparatus 1. Then, the selling price information database is able to change the selling price information according to the received content state information by responding with increasing and decreasing the current price of each digital content according to the playback state, and the like.

In this manner, during playback of a digital content, presenting the current price and the like according to the playback state of the digital content enables a user to view/listen the content while paying attention to that lowering of the current price is to be minimized and to sell the content at the moment when the current price thereof becomes as high as possible.

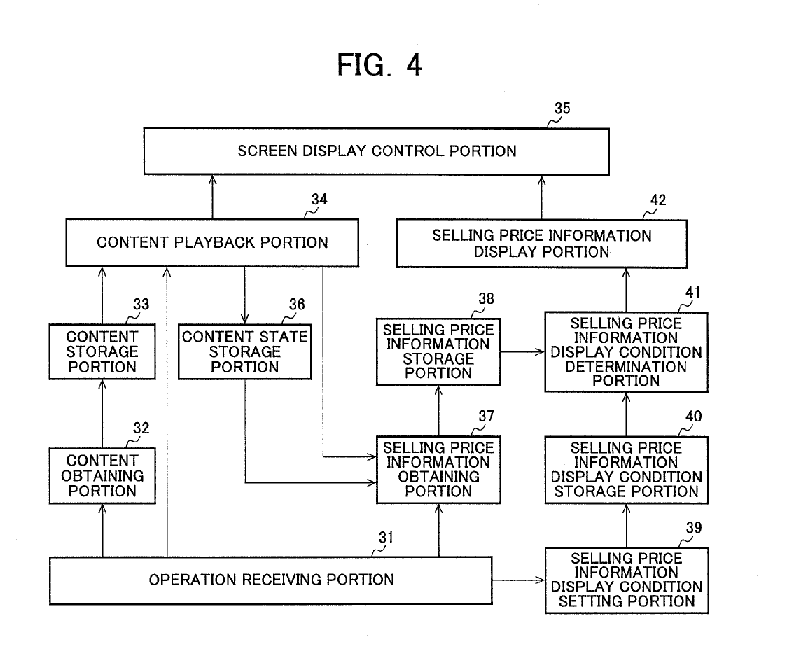

FIG. 4 is a diagram showing an example of a component of a program to be incorporated into the control portion in the content playback apparatus of FIG. 2. Note that, each portion shown in FIG. 4 can also be said as a functional block showing a configuration example of the content playback apparatus according to the present invention.

The control portion 14 in the content playback apparatus 1 of FIG. 2 is able to execute a program (firmware) for causing a calculation device of the control portion 14 to function by reading out thereof from the calculation device as an operation receiving portion 31, a content obtaining portion 32, a content storage portion 33, a content playback portion 34, a screen display control portion 35, a content state storage portion 36, a selling price information obtaining portion 37, a selling price information storage portion 38, a selling price information display condition setting portion 39, a selling price information display condition storage portion 40, and a selling price information display condition determination portion 41. The program may be stored inside the control portion 14 or stored in the memory portion 15.

The operation receiving portion 31 is to receive a user operation event that are notified from the operation portion 13. There are 4 types of the operation events. The first is a content obtaining operation event for newly obtaining a digital content, the second is a content playback operation event by which a digital content which has already been obtained is selected and reproduced or playback thereof is finished, and the third is a selling price information display operation event for obtaining the selling price information by a user operation, and a selling price information non-display operation event to stop displaying the selling price information by a user operation. The fourth is a selling price information display condition setting operation event for setting conditions for displaying the selling price information. Hereinafter, description for each of the portions 31 to 42 will be given based on the flow of the processing in which starting points of the processing are the four operation events.

In the case where the first content obtaining operation event is generated, the content obtaining portion 32 makes an obtaining request of a digital content for the content purchase/sales server 2 with use of the communication portion 12. The obtained digital content data is stored by the content storage portion 33 in the memory portion 15 with content specification information (content ID) with which a content is able to be specified.

In the case where the second content playback operation event is generated, the content playback portion 34 reads out the digital content specified by the content playback operation event from the memory portion 15 or the memory card I/F portion 21 and makes a decode request for the video image/sound decoding portion 16. Next, the screen display control portion 35 causes the screen synthesizing portion 19 to synthesize the decoded result and the display of the selling price information so as to be displayed on the display portion 20. Further, for a playback control request concerning the digital content (page forward, fast-forward, pause, or termination request) also, the content playback portion 34 performs playback control processing and makes a decode request for the video image/sound decoding portion 16 so as to be in the requested playback state. Further, playback processing of the content which is protected by the copyright is also performed by the content playback portion 34.

Furthermore, the content playback portion 34 passes a content ID and a playback state of a digital content being reproduced to the content state storage portion 36 to be accumulated in the memory portion 15.

Note that, the content state storage portion 36 stores not only the playback state notified by the content playback portion 34 but also sensing information obtained from the sensor portion 22 in association with the content ID. Thereby, playback history for each content is able to be accumulated more specifically.

Further, the content playback portion 34 notifies the selling price information obtaining portion 37 of the content ID of the digital content being reproduced. The selling price information obtaining portion 37 requests selling price information for the content purchase/sales server 2 via the communication portion 12 based on the content ID in the case where the third selling price information display operation event is generated. The selling price information which is a response from the content purchase/sales server 2 is obtained via the communication portion 12 and stored in association with the content ID in the memory portion 15 by the selling price information storage portion 38, and the selling price information display condition determination portion 41 is notified of obtaining the selling price information. Furthermore, the selling price information obtaining portion 37 stops obtaining the selling price information which is requested at present and in being obtained sequentially in the case where the selling price information non-display operation event is generated.

Here, the description has been given assuming that the selling price information is obtained after the selling price information display operation event is generated, however, in the case where the selling price information has been obtained already (for example, in the case of within a predetermined time such as within 1 minute or the like from obtaining the previous selling price information), obtaining the selling price information is able to be skipped to perform the display processing of the selling price information.

Moreover, the selling price information obtaining portion 37 starts the processing by the selling price information display operation event, as well as may start obtaining the selling price information with issuance of the selling price information obtaining request from the content state storage portion 36 when a content state accumulated in the content state storage portion 36 becomes a predetermined state. That is, the selling price information obtaining portion 37 obtains the selling price information when the selling price information obtaining conditions are satisfied such as in the case where the selling price information display operation event is generated, or in the case of becoming a predetermined state for obtaining the selling price information. As the predetermined state of satisfying the selling price information obtaining conditions, included are, for example, a state where a given time has elapsed from starting playback, a state where a display content of a content being displayed is switched, a state where the content being reproduced is paused, a state where a given time has elapsed from the previous change of the content state, and the like.

Further, the selling price information obtaining portion 37 not only passes the content ID as a request parameter at the time of requesting the selling price information, but also reads out from the memory portion 15 a playback state relating to the content ID from among the playback states stored by the content state storage portion 36 for adding to the request parameter. Thereby the selling price information varied depending on the playback state of the content is able to be obtained.

The selling price information is thus able to be obtained without a special operation for obtaining the selling price information by a user, and for example, new selling price information is able to be obtained each time a page of an electronic book is forwarded.

In the case where the fourth selling price information display condition setting operation event is generated, the selling price information display condition setting portion 39 obtains the conditions to display the selling price information, the selling price information display condition storage portion 40 stores the specified conditions in the memory portion 15 and the selling price information display condition determination portion 41 is notified that the conditions are set.

When a notification is made that the selling price information is obtained by the selling price information storage portion 38, or that the display conditions are set by the selling price information display condition determination portion 41, the selling price information display condition determination portion 41 compares the selling price information with the display conditions, and in the case of being matched to the conditions, the selling price information display portion 42 performs conversion into a display signal for presenting on the display portion 20 with use of the selling price information presentation processing portion 18, and the screen display control portion 35 causes the screen synthesizing portion 19 to synthesize content playback data and display data of the selling price information to display on the display portion 20.

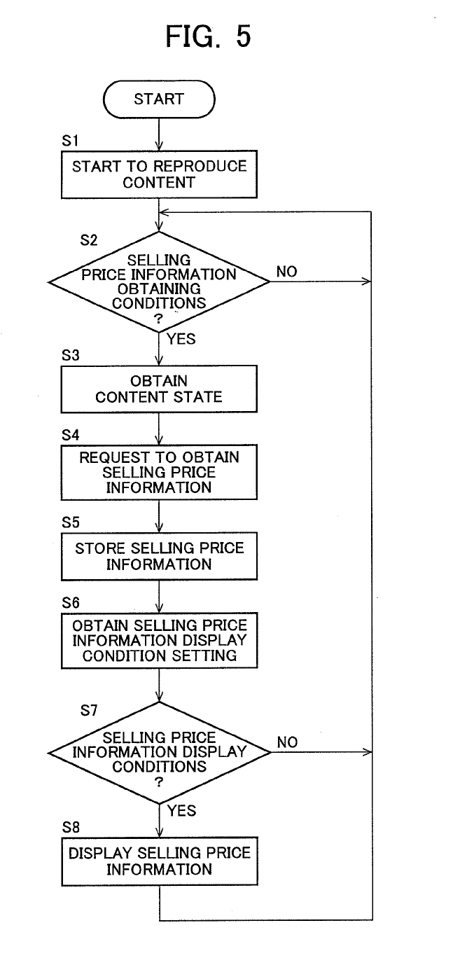

Next, with reference to FIG. 4 and FIG. 5, description will be given on how the selling price information is presented, namely, on a selling price information presentation procedure. FIG. 5 is a flowchart for describing an example of selling price information presentation processing in the content playback apparatus of FIG. 2. Note that, here, as described above, it is assumed that the digital content to be reproduced is already in the memory portion 15 or the memory card inserted in the memory card I/F portion 21 of the content playback apparatus 1. Furthermore, it is assumed that the selling price information display conditions are also stored in the memory portion 15 in advance.

First, when the operation receiving portion 31 receives a content playback operation event, processing is started and playback of a digital content is started with use of the content playback portion 34 (step S1). Next, determination is made on whether selling price information obtaining conditions are satisfied (step S2). In the case of being determined to be satisfied at step S2, the process shifts to next step S3. In the case of not being satisfied, it is waited until being satisfied.

In the case of being determined to be satisfied at step S2, the selling price information obtaining portion 37 obtains a content state from the content state storage portion 36 (step S3), and subsequently, the selling price information obtaining portion 37 performs processing to make an obtaining request including the content state information, namely, processing to obtain the selling price information from the content purchase/sales server 2 (step S4), and the selling price information is stored in the memory portion 15 with use of the selling price information storage portion 38 (step S5).

When a notification is received that the selling price information is stored by the selling price information storage portion 38 at step S5, the selling price information display condition determination portion 41 reads out the selling price information display conditions from the selling price information display condition storage portion 40 for performing determination (step S6). Subsequently, the selling price information display condition determination portion 41 determines whether or not the selling price information display conditions are satisfied from the selling price information stored by the selling price information storage portion 38 and the selling price information display conditions stored by the selling price information display condition storage portion 40 (step S7). In the case where the conditions are not satisfied, the process shifts to step S2 for repeating the above-described processing. In the case where the conditions are satisfied, a digital content playback screen and selling price information are displayed with use of the selling price information display portion 42 and the screen display control portion 35 (step S8), and the process shifts to step S2 again.

Here, supplementary description for steps S2 and S7 will be given. As combinations of the obtaining conditions and display conditions of the selling price information at steps S2 and S7, for example, the following 3 cases such as (1) to (3) may be considered.

(1) The selling price information is displayed by obtaining the selling price information (as necessary) due to a selling price information display operation event and by automatically determining as YES also in the determination of the selling price information display conditions (namely, employing the selling price information display conditions such as receiving the same event or obtaining the selling price information). That is, obtaining and displaying the selling price information are executed by a manual operation. A case where such display as illustrated in FIG. 3A is realized by a user operation corresponds to this. For such realization, when the selling price information display operation event is generated concerning the determination at step S2, the determination according to the selling price information display conditions at step S7 is made to be YES all the time so that displaying the selling price information at step S8 may be executed. Of course, displaying the selling price information at step S8 maybe executed without passing through the determination at step S7 when the selling price information display operation event is generated concerning the determination at step S2.

(2) The selling price information is displayed by obtaining the selling price information by satisfying the selling price information obtaining conditions such as the content state becoming a predetermined state and the like, and determining as YES in selling price information display condition determination due to the selling price information display operation event (namely, employing the selling price information display conditions such as receiving the same event). That is, the selling price information is obtained automatically based on the obtaining conditions and the display of the selling price information is executed by a manual operation.

(3) The selling price information is obtained by satisfying the selling price information obtaining conditions such as the content state becoming a predetermined state and the like. The selling price information is displayed by determining as YES in the selling price information display condition determination due to obtaining of the selling price information (namely, employing the selling price information display conditions such as obtaining the selling price information). That is, obtaining and displaying the selling price information are automatically executed.

Hereinabove, description has been given for various forms of the present invention on the assumption that the values of the selling price information at present are presented as the selling price information. That is, in each form as described above, description concerning database of the content purchase/sales server 2 has been given for a case where increase/decrease data of a current price due to a playback state of each digital content is also managed in addition to a current price of the digital content and fluctuation history of the current price, and the like, and in requesting selling price information from the content playback apparatus 1, notification of a content ID and the playback state of the digital content as a parameter is made, and selling price information according to the playback state is thus provided.

However, the content playback apparatus 1 according to the present invention may present selling price information that is predicted (estimated). That is, the content purchase/sales server 2 is able to estimate a current price in future for providing as selling price information according to a playback state of a digital content for which selling price information is requested. Then, in the selling price information presented by the selling price information presentation portion of the content playback apparatus 1, estimate selling price information estimated from the playback state information may be included. The estimate selling price information is preferable to be estimated based on a playback finishing time estimated from the playback state information. The prediction may be utilized advantageously especially for the current price, and may also be applied for other information.

Description will be given for a specific processing example. The playback completion estimate time is estimated by obtaining the total number of pages or a total playback time of the content from meta-information of the content corresponding to a content ID, and obtaining playback finished pages and a playback elapsed time at present from a content playback state which is notified as a parameter from the content playback apparatus 1. By predicting the number of selling orders based on the variation history of the current prices and the playback completion estimate time of other users, the current price at the playback completion estimate time is estimated so that a response is able to be made with the estimation included in the selling price information.

In this manner, the content playback completion estimate time is estimated based on the content state information including the playback process of the digital content being reproduced and the current price at the content playback completion estimate time is calculated, so that not only the current price at the content playback completion time but also the predicted value of the current price in future is able to be presented. Here, the content playback completion estimate time is calculated by the content playback apparatus 1 from the total number of pages, the total playback time or the like stored in the meta-information of the digital content, or is calculated by the content purchase/sales server 2 similarly from the total number of pages, the total playback time or the like of the content based on the content state information and the content specification information.

Furthermore, although the case where the selling price information is estimated inside the content purchase/sales server 2 has been described, the estimation may be performed on a side of the content playback apparatus 1. That is, in the content playback apparatus 1, the total number of pages or the total playback time of the content is obtained from the meta-information of the content corresponding to the content ID and the playback finished pages and the playback elapsed time at present are obtained from the content playback state so that the playback completion estimate time is able to be estimated. Furthermore, from the fluctuation history of the current prices included in the selling price information obtained from the content purchase/sales server 2, a current price at a playback completion estimate time is estimated so that an estimated current price is able to be added to the selling price information.

In this way, a predicted value of the current price at the content playback completion estimate time is also presented, the user is thus able to view/listen a digital content while adjusting apace of viewing/listening thereof so as to sell the content in a state where the current price is as high as possible.

Hereinabove, description has been given for the content playback apparatus according to the present invention, however, as described for the flow of the processing, the present invention may employ a form of a content playback method in which a digital content is reproduced by the content playback apparatus. The content playback method includes an obtaining step in which a selling price information obtaining portion obtains selling price information concerning a digital content, and a presenting step in which the selling price information presentation portion presents the selling price information obtained at the obtaining step. The presenting step then performs, during playback of a digital content, presentation of the selling price information concerning the digital content. Other application examples are the same as that is described for the content playback apparatus, and a description thereof is thus omitted.

For example, the content playback method according to the present invention is able to be realized by being incorporated into the above-described content playback apparatus (dedicated apparatus, general-purpose PC or PDA, etc.,) as a content playback program. For example, the content playback program such as a program for realizing the processing procedure in FIG. 5 is stored in the control portion 14 itself in advance or in the memory portion 15 in advance and executed by the control portion 14, as described above.

Moreover, the present invention may employ a form as such a content playback program or a computer-readable recording medium recording thereof.

The content playback program is a content playback program for playback the digital content and the program to cause a computer to execute an obtaining step for obtaining selling price information concerning a digital content, and a presenting step for presenting the selling price information obtained at the obtaining step. The presenting step then performs, during playback of a digital content, presentation of the selling price information concerning the digital content. Other application examples are the same as that is described for the content playback apparatus, and a description thereof is thus omitted.

The content playback program may be distributed by storing in a computer-readable recording medium. The recording medium includes various things including an optical disc such as a CD-ROM, a DVD-ROM, or a non-volatile semi-conductor memory such as a memory card. Furthermore, the content playback program is able to be distributed via a communication network, or the broadcast wave. Then, the content playback program is stored in a storage device (memory portion 15 or memory inside control portion 14) inside the content playback apparatus in a state where the program is executable by reading out in an execution area such as a RAM by the control portion (CPU, etc.,) of the content playback apparatus, whereby a function of presenting selling price information according to the present invention is able to be realized. For example, in the case of distribution by the recording medium, the recording medium may be inserted into the memory card I/F portion 21, read out from the recording medium via a not-shown drive externally connected to the content playback apparatus 1 so as to be executed by the control portion 14, or installed in the memory portion 15 so as to be executed by the control portion 14. Further, in the case of distribution via the communication network, a program which is downloaded from the internet or the like with use of the communication portion 12 may be installed in the memory portion 15, for example, so as to be executed by the control portion 14. In the case of distribution via the broadcast wave, a program received by a not-shown broadcast receiving portion may be installed in the memory portion 15, for example, so as to be executed by the control portion 14.

Description has been given hereinabove for the present invention along with effects thereof. In the present invention, basically, a system is assumed in which a user is able to freely purchase and sell a digital content any time as with the current non-digital content, and any user is capable of purchasing and selling equally while a selling destination is limited to a digital content exchange such as a securities exchange. Furthermore, in the exchange, companies which mediate purchasing and selling digital contents corresponding to securities companies or a system thereof may exist. Capability of purchasing and selling the digital contents as with the stocks means that a net investment is able to be performed such that a plurality of contents are bought and sold for locking in profits in the case of appreciation thereof, or the contents are borrowed by a purchase/sales intermediate company in the case of the high appreciation thereof and short-selling thereof is performed, and subsequently purchase back thereof in the case of depreciation in order to gain differential profit. When such a market is established, the presentation of the selling price information during playback of a content according to the present invention becomes quite advantageous.

As described above, according to the present invention, during playback of a digital content, it is possible to present selling price information for the digital content being reproduced.

1. A content playback apparatus comprising:
a content playback portion which reproduces a digital content;
a selling price information obtaining portion which obtains selling price information concerning the digital content; and
a selling price information presentation portion which presents the selling price information; wherein
the selling price information presentation portion presents the selling price information concerning the digital content during playback of the digital content.

2. The content playback apparatus as defined in claim 1, wherein the selling price information presentation portion presents the selling price information in a case where selling price information presentation conditions set in advance are satisfied.

3. The content playback apparatus as defined in claim 1, wherein an operation receiving portion is provided which receives a presentation operation for executing presentation by the selling price information presentation portion during playback of the digital content, and the selling price information presentation portion executes presentation of the selling price information when the presentation operation is received.

4. The content playback apparatus as defined in claim 1, wherein a state accumulation portion is provided which accumulates playback state information showing a playback state of the digital content for each of the digital content, and the selling price information obtaining portion obtains the selling price information corresponding to the playback state information concerning the digital content being reproduced.

5. The content playback apparatus as defined in claim 4, wherein the selling price information presented by the selling price information presentation portion includes estimate selling price information which is estimated from the playback state information.

6. The content playback apparatus as defined in claim 1, wherein the selling price information obtaining portion obtains the selling price information concerning the digital content from a server device connected to the content playback apparatus via a network.

7. A content playback method for reproducing a digital content by a content playback apparatus including:
an obtaining step in which a selling price information obtaining portion obtains selling price information concerning the digital content; and
a presenting step in which a selling price information presentation portion presents the selling price information obtained at the obtaining step, wherein
the presenting step performs presentation of the selling price information concerning the digital content during playback of the digital content.

8. A program for reproducing a digital content in which a computer is caused to execute an obtaining step for obtaining selling price information concerning the digital content, and a presenting step for presenting the selling price information obtained at the obtaining step, wherein the presenting step performs presentation of the selling price information concerning the digital content during playback of the digital content.

9. A computer-readable recording medium in which the program as defined in claim 8 is recorded.
